(19) United States
(12) Patent Application Publication
(10) Pub. No.: US 2024/0095911 A1
(43) Pub. Date: Mar. 21, 2024

(54) ESTIMATING PROPERTIES OF PHYSICAL OBJECTS, BY PROCESSING IMAGE DATA WITH NEURAL NETWORKS

(71) Applicant: BASF SE, Ludwigshafen am Rhein (DE)

(72) Inventors: Rahul TANEJA, Darmstadt (DE); Kamran SIAL, Limburgerhof (DE); Till EGGERS, Ludwifshafen (DE); Margret KEUPER, Homburg (DE); Ramon NAVARRA-MESTRE, Limburgerhof (DE); Sebastian FISCHER, Limburgerhof (DE); Mike SCHARNER, Limburgerhof (DE); Javier ROMERO RODRIGUEZ, Utrera (ES); Francisco Manuel POLO LOPEZ, Utrera (ES); Andres MARTIN PALMA, Utrera (ES)

(21) Appl. No.: 18/284,484

(22) PCT Filed: Mar. 31, 2022
(86) PCT No.: PCT/EP2022/058723

§ 371 Date: Sep. 27, 2023

(30) Foreign Application Priority Data
Mar. 31, 2021 (EP) 21166479.2

(51) Int. Cl. G06T 7/00; A01G 7/00; G06T 7/62; G06V 10/764; G06V 20/10

(52) U.S. Cl. CPC G06T 7/0012; A01G 7/00; G06T 7/0004; G06T 7/62; G06V 10/764; G06V 20/188; G06T 2200/24; G06T 2207/20081; G06T 2207/20084; G06T 2207/30004; G06T 2207/30188

(57) ABSTRACT

The present disclosure relates to image processing or computer vision techniques. A computer-implemented method is provided for determining a damage status of a physical object, the method comprising the steps of receiving a surface image of the physical object; and providing a pre-trained machine learning model to derive property values from the received surface map, wherein each property value is indicative of a damage index at a respective location, wherein the property values are preferably usable for monitoring and/or controlling a production process of the physical object. In this way, it is possible to reliably identify local defects and ensure that it is accurate enough to apply the chemical products in suitable amounts.

### TECHNICAL FIELD

The disclosure generally relates to image processing or computer vision techniques. More specifically, the present disclosure relates to a computer-implemented method and an apparatus for determining a damage status of a physical object, to a computer-implemented method and an apparatus for generating a trained neural network usable for determining a damage status of a physical object, to a method and a system for controlling a production process, and to a computer program element.

### BACKGROUND

In the technical field of agriculture, there is steady push to make farming or farming operations more sustainable. Precision farming or agriculture is seen as one of the ways to achieve better sustainability and reducing environmental impact. This relies on the reliable local detection of plant damage in the field. In production environment, monitoring and/or controlling a production process based on images also relies on the reliability of detection of defects and the precise localization of defects. Thus, there is a need of reliably identifying local defects. There is a need to improve the computer vision techniques such that it is accurate enough to apply the chemical products in suitable amounts. Further there is a need to improve computer vision, for the application in production environment.

### SUMMARY OF THE INVENTION

In one aspect of the present disclosure, a computer-implemented method is provided for determining a damage status of a physical object, the method comprising the following steps:
receiving a surface image of the physical object; and
providing a pre-trained machine learning model to derive property values from the received surface map, wherein each property value is indicative of a damage index at a respective location, wherein the property values are preferably usable for monitoring and/or controlling a production process of the physical object.

In another aspect of the present disclosure, a method is provided for controlling a production process, comprising:
capturing a surface image of a physical product;
providing a pre-trained machine learning model to derive property values from the received surface map, wherein each property value is indicative of a damage index at a respective location;
identifying and locating, based on the derived property values, a damaged location; and
generating control data that comprises instructions for controlling a treatment device to apply treatment to the identified location.

In a further aspect of the present disclosure, a computer-implemented method is provided for generating a trained neural network usable for determining a damage status of a physical object, the method comprising:
providing a training set comprising surface images with annotated surface properties values for physical objects that are shown on the surface images, wherein the annotated surface properties values comprise a damage index indicative of a percentage of an imaged surface area of the physical object being damaged;
training the neural network with the provided training set, wherein in the training process, training surface images are communicatively coupled to the input of at least one convolutional layer of the neural network and the property values are communicatively coupled to a global average module that calculates the global average of map-pixels of the property map at the output of the at least one convolutional layer.

In a further aspect of the present disclosure, an apparatus is provided for generating a trained neural network usable for determining a damage status of a physical object, the apparatus comprising:
an input unit configured to receive a training set comprising surface images with annotated surface properties values for physical objects that are shown on the surface images, wherein the annotated surface properties values are indicative of a damage index of one or a plurality of surface points and/or areas of the physical object;
a processing unit configured to train the neural network with the provided training set, wherein in the training process, training surface images are communicatively coupled to the input of at least one convolutional layer of the neural network and the property values are communicatively coupled to a global average module configured to calculate the global average of map-pixels of the property map at the output of the at least one convolutional layer; and
an output unit configured to provide the trained neural network, which is preferably usable for determining a damage status of a physical object.

In a further aspect of the present disclosure, an apparatus is provided for determining a damage status of a physical object, the apparatus comprising:
an input unit configured to receive a surface image of the physical object; and
a processing unit configured to apply a pre-trained machine learning model to derive property values from the received surface map, wherein each property value is indicative of a damage index at a respective location; and
an output unit configured to provide the property values, which are preferably usable for monitoring and/or controlling a production process of the physical object.

In a further aspect of the present disclosure, a system is provided for controlling a production process, comprising:
a camera configured to capture a surface image of an physical object;
an apparatus configured to provide property values derived from the received surface map, wherein each property value is indicative of a damage index at a respective location; and
an object modifier configured to perform, based on the property values, an operation to act on the one or more damaged locations of the physical object.

In a further example, a computer program product is provided that comprising instructions which, when the program is executed by a processing unit, cause the processing unit to carry out the steps of the method disclosed herein.

Any disclosure and embodiments described herein relate to the method, the apparatus, the system, and the computer program element lined out above and vice versa. Advantageously, the benefits provided by any of the embodiments and examples equally apply to all other embodiments and examples and vice versa.

As used herein “determining” also includes “initiating or causing to determine”, “generating” also includes “initiating or causing to generate” and “providing” also includes “initiating or causing to determine, generate, select, send or receive”.

In agriculture and in industry, physical objects provide effects across their surfaces. In many cases, the surfaces are substantially flat. For example, the physical objects can provide agricultural products (such as fields that provide crops) or provide industrial applications (such as rubber mats that provide thermal insulation). The effects may be distributed across the surface in a non-equal fashion. Some surface areas provide more, other surface areas provide less effects. In theory, human observers could interact with the physical objects to distribute the effects more homogeneously. However, the observers need to differentiate the properties for different surface areas. But the size of the physical objects (or its location) may prevent human observers to visually inspect their surfaces. The physical objects may simply too large for the observer to complete an inspection of all parts of the objects, or the physical object may be difficult to reach.

Towards this end, a method, a system, an application device, and a computer element are provided, which provide an efficient, reliable way for identifying a damaged on a surface of a physical object. In some examples, the physical objects may be an agricultural field, and the damage may be plant damage. In some examples, the physical object may be an industrial product, and the damage may be a deviation of one or more surface areas from a standard. In particular, for training the neural network, surface images of the physical object are provided. Annotated surface properties are provided which are global values covering the imaged surface area, e.g. 30% of the shown area is damaged. This assessment may be performed based on visual inspection by an expert by visual inspection of the image. However, the expert does not need to annotate individual pixels. During deployment, the trained neural network is able to identify a damaged location (e.g., an area) in a surface image acquired from another physical object. Therefore, selective treatment of the damaged location can be provided. Two exemplary application scenarios will be described below.

### First Scenario

In a first scenario, the physical object is an agricultural field that let crop plants grow. The growth of the plants is usually far from being ideal. For example, the plants can be damaged or otherwise affected. In a first example, the plants are damaged by a disease. Septoria are fungi that produce substances, and these substances may damage the leaves of the crops. For example, the substances may be poison to the crop. The damage may be visible as leaf spots any may cause yield loss. In a second example, insects or other animals may cause damage because they simply eat from the crop plants. In a third example, the damage is the lack of growth.

The observers are farmers that can interact with the physical object by applying damage-specific measures. For example, the farmers can distribute chemical products (i.e., to the crops plants on the field), such as fungicides (against Septoria or other fungi), pesticides (against the insects), to apply fertilizers (to stimulate crop growth) and so on. It is expected that such measures let the crop plant grow normally again.

As chemical products require application in suitable amounts, the farmers usually identify quality and quantity of the damage when they look at the field. In a sampling approach, the farmers would visually inspect some individual plants. If time allows, the farmers would go to several locations of the field. Whenever possible, the farmers look at the field before and after applying the product.

However—and to keep the discussion with the first scenario (first example)—diseases (and other damages) do not affect the agricultural fields equally. Some areas in the field may show less or more damage than other areas. The farmers may extrapolate the estimations from some plants to substantially all plants in the field, but they may derive inappropriate measures.

A farmer may inspect plants at easy-to-go locations within the field. The farmer may take the plant at the edges of the field as the basis for measures, but may misunderstand the situation and therefore apply the measures in potentially non-appropriate amounts of chemicals. The farmer may even waste some of the chemical products, and thereby harm the environment.

Computer vision techniques appear as improvement. Cameras can take images from the fields, for example if mounted on unmanned aerial vehicles (UAV), aircraft or the like. However, the real world of the fields is different from the virtual world of the images. Farmers look at individual plants (in the real world) and may immediately understand the growth status of the plant (e.g., recognize damage), with the insufficiencies already mentioned. But farmers looking at an image may not recognize the status, even if the image shows many plants.

Further, it is very complicated (or even impossible) for farmers to interpret images. Although in some cases the farmers may come to a valid conclusion, different farmers may interpret images differently. Consequently, the application of chemical products may become non-equal for that reason alone.

With the method, system, application device and/or computer element as disclosed herein, a damaged on a surface of a physical object can be identified in an efficient, reliable way. In this way, the farmers can understand damages, in a granularity that takes non-equality of the fields into account and that is accurate enough to apply the chemical products in suitable amounts.

Further, in the technical field of agriculture, there is steady push to make farming or farming operations more sustainable. Precision farming or agriculture is seen as one of the ways to achieve better sustainability and reducing environmental impact. This relies on the reliable local detection of plant damage in the field. With the method, system, application device and/or computer element as disclosed herein, identification, where in the field plant damage occurs allows a precise local treatment. This enables a reduction in use of crop protection products. This reduces the environmental load of farming, making it more sustainable.

### Second Scenario

A second scenario looks at industrial manufacturing. The physical object is an industrial product, and at least one its surfaces may show a deviation from normal (or from a standard). For example, the object can be a mat made by a chemical process, and the object may be damaged on its surface at least partially.

Again, the situation can be improved as deviations from normal (such as damages or the like) at the physical objects are detected at the granularity of particular surface areas with the method, system, application device and/or computer element as disclosed herein. Appropriate measures can then be applied, to the surface, and/or to the object as a whole.

It is an object of the present invention to provide an efficient way of protecting crops on an agricultural field or improving the product quality of an industrial product. These and other objects, which become apparent upon reading the following description, are solved by the subject matters of the independent claims. The dependent claims refer to preferred embodiments of the invention.

The term “agricultural field” as used herein refers to an agricultural field to be treated. The agricultural field may be any plant or crop cultivation area, such as a farming field, a greenhouse, or the like. A plant may be a crop, a weed, a volunteer plant, a crop from a previous growing season, a beneficial plant or any other plant present on the agricultural field. The agricultural field may be identified through its geographical location or georeferenced location data. A reference coordinate, a size and/or a shape may be used to further specify the agricultural field.

The term “damage” as used in the context of the present application may comprise any deviation of the property values from standard property values. Examples of the damage may include plant damages and industrial product damages.

The term “plant damage” as used in the context of the present application may comprise any deviation from the normal physiological functioning of a plant which is harmful to a plant, including but not limited to plant diseases (i.e. deviations from the normal physiological functioning of a plant) caused by:
a) fungi (“fungal plant disease”),
b) bacteria (“bacterial plant disease”)
c) viruses (“viral plant disease”),
d) insect feeding damage,
e) plant nutrition deficiencies,
f) heat stress, for example temperature conditions higher than 30′C,
g) cold stress, for example temperature conditions lower than 10° C.,
h) drought stress,
i) exposure to excessive sun light, for example exposure to sun light causing signs of scorch, sun burn or similar signs of irradiation,
j) acidic or alkaline pH conditions in the soil with pH values lower than pH 5 and/or pH values higher than 9,
k) salt stress, for example soil salinity,
l) pollution with chemicals, for example with heavy metals, and/or
m) fertilizer or crop protection adverse effects, for example herbicide injuries
n) destructive weather conditions, for example hail, frost, damaging wind.

The term “image” or “image data” as used herein is to be understood broadly in the present case and comprises any data or electromagnetic radiant imagery that may be obtained or generated by one camera, one image sensor, a plurality of cameras or a plurality of image sensors. Image data are not limited to the visible spectral range and to two dimensionalities. Thereby, also cameras obtaining image data in e.g. the infrared spectral range are included in the term image data. The frame rate of the camera may be in the range of 0.3 Hz to 48 Hz, but is not limited thereto.

The term “treatment device”, also referred to as application device, is to be understood broadly in the present case and comprises any device being configured to perform a measure to reduce the damage. In the case of agricultural field, the treatment device may apply a crop protection product onto an agricultural field. The application device may be configured to traverse the agricultural field. The application device may be a ground or an air vehicle, e.g. a tractor-mounted vehicle, a self-propelled sprayer, a rail vehicle, a robot, an aircraft, an unmanned aerial vehicle (UAV), a drone, or the like.

### Input and Output

The following disclosure describes an approach with a computer-implemented method (as well as a system and a computer program) for quantifying properties of a physical object in the granularity of individual surface points of the physical object. As used herein, granularity refers to resolution in space.

In short, the computer quantifies properties (of the physical object) that appear at the surface. As the surface (of the physical object) must allow taking an image, it is convenient that the surface is substantially flat. However, this is not mandatory.

The computer has processing modules that are arranged in the topology of a neural network (or “network” in short). The network has an input to receive a surface image and an output to provide a property map.

The surface image is an image showing the surface (of the physical object). As images are collection of pixels, the surface image allows a viewer (a user, or other entity) to virtually divide the surface into smaller portions, or “surface points” in the following. Position correspondence applies: Individual positions (X, Y) of the surface points correspond to individual position data (x, y) of the pixels in the surface image.

The pixels in the surface image have data channels with real-world data (because the image shows the physical object that is located in the real world). The real-world data comprises color data. The individual pixels in the surface image have channels which corresponds to light reflectance of a specific wavelength. The number of channels depends on the camera type. For example, an RGB camera has three channels.

Human viewers of the surface image may relate color information to individual surface points. However, this is not yet an indication of object properties, let alone of any quantization.

The computer (with the network) provides the quantifiers in the property map, having pixels as well. These property pixels provide the quantifiers (as property values). The computer maintains the position correspondence: individual pixel position data (x, y) of the surface image correspond to individual pixel position data (x, y) of the property map. The same observation applies in opposite perspective: the position data of the property map matches the position data in the surface image.

Therefore, individual positions (X, Y) of the surface points correspond to individual pixel position data (x, y) of the property map. In other words, surface points (in the real-world) correspond to property pixels. Or, the property pixels match the surface points, the property values are therefore point-related values.

This bijective relation (i.e., correspond/match) allows the user who inspects the property map to interact with the physical object at surface point granularity.

In the above-mentioned first scenario in its first example, the user can inspect the property map that differentiates areas of the agricultural field (i.e., surface points in general notation) according to the presence or absence of fungi; and the user can trigger the application of fungicides to individual areas.

### Neural Network

The computer provides the property values in the property map in the channel of the property pixels. The property pixels can have a single channel. The property values can be numeric values (in form of real numbers), such as percentages or absolute values, or the property values can be classifiers (binary classifiers, indicating the presence or absence of a particular property, multi-class classifiers).

The surface image has a pixel dimension that corresponds to the pixel dimension at the input of the network. Pixel dimensions are 2D dimensions, with W (width) and H (height) given in pixel numbers.

The property map at the output of the network keeps that 2D dimension. Position granularity is highest if every surface point would have its corresponding pixel in the property map (same number of pixels and same aspect ratio for both the surface image and the property map).

Position granularity is still acceptable (for the user to make a decision regarding measures) if two or more surface points have a corresponding common pixel in the property map, and/or if the aspect ratio changes.

Optionally, the computer can visually present the property map at the output of the network to the user. The computer would then show the property map as a so-called heatmap (with particular display colors previously assigned to particular property values).

Optionally, the computer aggregates the quantifiers for the physical object (in the property map) as an aggregation value for the property map as a whole.

In the neural network, the computer processes data by processing modules (or “layers”). The neural network has an input layer to receive the surface image (i.e., with point-pixels), and has an output layer to provide the property map (i.e., with property pixels).

The computer operates in a training phase and in a testing phase. As used herein, the term “computer” stands for the concept of data processing in general. However, training and testing can be implemented by separate physical computers.

Looking at the arrangement of network layers between the input layer and the output layer, the network further comprises more than one intermediate layer (so-called hidden layers).

The network is therefore a so-called “deep network”. The input layer LAY(1) receives the surface image and provides the first intermediate map MAP(1). The output-layer LAY(N) receives the last intermediate map MAP(N-1) and provides the property map MAP(N). The (N-2) layers between LAY(1) and LAY(N) are the hidden layers.

Looking at the data processing performed by the layers, the layers are modify-layers and (optional) bypass-layers.

In general, the modify-layers form a chain or processing sequence. The modify-layers apply operations such as convolution operations (involving filter weights, obtained by training), pooling and up-sampling operations (involving pre-defined, non-trained parameters), and other operations (such as RELU).

Accordingly, the modify layers are convolution layers, pooling layers, up-sampling layers, and RELU layers. The RELU layers can conveniently be implemented into the convolution layers, but they also can be implemented separately.

Due to the application of convolution, the network is a convolutional neural network (CNN). The convolutional layers provide feature maps.

### Two Constraints

The network is a sequence of layers that process the surface image to the property map, but there are least the following two accuracy constraints:

First, pooling and up-sampling operations inherently change the pixel dimensions of the feature maps, by reducing or increasing the number of pixels. Position data loses its accuracy during pooling, but up-sampling does not regain the accuracy.

There is a requirement to restore the position data for the property map to the granularity of the surface image.

Second, since the network quantifies properties of the object, the network must be trained with sample properties for sample objects. However, training data in the granularity of the output—property pixels for individual surface points—is not generally available. In other words, point-specific annotations are missing.

The accuracy constraints are addressed by two implementation particulars of the network: (1) The pooling and up-sampling layers process position data as well, and (2) The training minimizes loss between position-agnostic training data (also being property data, but annotated) and position-aware but aggregated property data.

The implementation particulars do not address the constraints separately, but rather act in a synergistic way.

The pooling layers identify groups of adjacent pixels within the feature maps (i.e., output of convolution layers), but retain the position data (not the position, but the data) of the pixels with extreme data values among the pixels of the group (such as highest, or lowest data values). The up-sampling layers places groups of up-sampled pixels to a position (identified by the retained position data) to an property map with map-pixels.

The neural network uses an aggregator as a further processing module. The aggregator is not necessarily a layer in the above-described function (no image or map as output) but a module that processes the channel data of the property map (at aggregator input) to an overall value (at aggregator output), that means to a surface-related value. (The notation “surface-related” also applies as “object-related”). Alternatively, the aggregator can receive data from an intermediate map.

In an embodiment, the aggregator calculates the average of the channel data over the pixels of the property map, that is so-called global average over the real numbers. Or, the aggregator calculates the share of pixels for both classification categories. However, there can be more than two classification categories (e.g., classes such as “no damage”, “low damage”, “high damage”).

As mentioned, the pixels of the property map can have only a single channel and that channel holds the property values.

In the testing phase, the computer can display the property map as a heatmap and can display the surface-related values optionally, the use of the aggregator is a convenient add-on.

### Operation During Training

In the training phase, the computer runs the neural network with a training set that comprises a plurality of training images that are surface images, and a corresponding plurality of annotations with properties for the objects shown on the training image at (least) in surface-related granularity.

The annotations are conveniently made by experts. In view of the first scenario, first example, the expert could annotate damage percentages (e.g., 0% to an image from a healthy field, 50% to an image from a field in the fungi has destroyed half of the field, and so on).

The computer receives the training surface images by the input layer and receives the annotations (surface-related values) by the aggregator.

### Operation During Testing

The computer derives the property values (being point-related values) by operating the neural network. It (i) provides feature maps at the outputs of the multiple convolutional layers, (ii) pools the feature maps to pool-maps by at least one pooling layer, from groups of adjacent pixels within the feature maps, wherein the pooling layer retains the position data of the pixels having extreme values in the groups, and (iii) up-samples the pool-maps by at least one up-sampling layer that places groups of up-sampled pixels to the retained position to a property map with property pixels. The property map has a pixel dimension that corresponds to the pixel dimension of the surface image.

According to the computer-implemented method for determining a damage status of a physical object or according to the method for controlling a production process, the pre-trained machine model has been trained on a training set that comprises surface images with annotated surface properties values for physical objects that are shown on the surface images, wherein the annotated surface properties values comprise a percentage of an imaged surface area of the physical object being damaged.

According to the computer-implemented method for determining a damage status of a physical object or according to the method for controlling a production process, if the damage index at a surface area is equal to or greater than a threshold, the surface area is determined to be a damaged location.

According to the computer-implemented method for determining a damage status of a physical object or according to the method for controlling a production process, the damage index of the one or the plurality of surface areas of the physical object is provided as a damage percentage, which is preferably usable to determine an amount of treatment to be applied to the one or the plurality of surface areas.

According to the computer-implemented method for determining a damage status of a physical object or according to the method for controlling a production process, based on the damage index of the one or the plurality of surface areas of the physical object, an application map is generated indicative a two-dimensional spatial distribution of an amount of the treatment which should be applied on different surface areas of the physical object. According to the computer-implemented method for determining a damage status of a physical object or according to the method for controlling a production process, the physical object comprises an agricultural field, and the treatment comprises an application of a product for treating a plant damage. Alternatively, the physical object comprises an industrial product, and the treatment comprises a measure to reduce the deviation of the one or the plurality of surface areas.

According to the computer-implemented method for generating a trained neural network usable for determining a damage status of a physical object, the physical object comprises an agricultural field, and the damage index is indicative of a plant damage.

According to the computer-implemented method for generating a trained neural network usable for determining a damage status of a physical object, the physical object comprises an industrial product, and the damage index is indicative of a deviation of the one or more surface areas from a standard.

According to the computer-implemented method for generating a trained neural network usable for determining a damage status of a physical object, the property values are relative values in respect to a standard, or wherein the surface property values are absolute values.

According to the computer-implemented method for generating a trained neural network usable for determining a damage status of a physical object, the property values (V(X,Y)) as provided as a two-dimensional map (“heatmap”, “mask”) in a pixel resolution that substantially corresponds to the pixel resolution of the surface image.

According to the computer-implemented method for generating a trained neural network usable for determining a damage status of a physical object, the method further comprises a step of providing by a user and/or receiving by the user the neural network.

According to the computer-implemented method for generating a trained neural network usable for determining a damage status of a physical object, the method further comprises a step of providing a user interface allowing a user to provide the surface images and the annotated surface properties values.

In the following, further embodiments are described:

According to embodiment 1, there is provided a computer-implemented method (400) for quantifying properties of a physical object (100) in the granularity of individual surface points (120) of the physical object (100), the method (400) comprising the following steps:
receiving (410) a surface image (210) with real-world data for the physical object (100) with channel data (Zk) and with position data (x,y), wherein the position data (x,y) of the pixels in the surface image (210) match the positions (X,Y) of the surface points (120) within the physical object (100);
deriving (420) property values (V(X,Y) being point-related values, by operating a neural network (370), wherein the neural network (370) provides at least one feature map (Map(1)) at the output of at least one convolutional layer (Lay(1)), the at least one feature map being a property map (270) having a pixel dimension (W, H) that corresponds to the pixel dimension (W, H) of the surface image,
wherein the neural network (370) has been trained previously with a plurality of annotated training images (215), being training surface images (215) with expert-annotated property values (V_train), wherein the training surface images (210) had been communicatively coupled to the input of the at least one convolutional layer (Lay(1)) and the expert-annotated property values (V_train) had been communicatively coupled to a global average module (G_AVG) that calculated the global average of map-pixels of the property map (270).

According to embodiment 2, which includes the subject matter of embodiment 1, the neural network (370) has multiple convolutional layers (Lay(1), Lay(2), Lay(5)), that provide multiple feature maps (Map(1), Map(2), Map(5)) at their outputs.

According to embodiment 3, which includes the subject matter of embodiment 2, the neural network (370) pools the feature maps to pool-maps (Map(3)) by at least one pooling layer (Lay(4)), from groups (250) of adjacent pixels within the feature maps (Map(2)), wherein the pooling layer (Lay(3)) retains the position data (251) of the pixels having extreme values in the groups (250), up-samples the pool-maps (Map(3)) by at least one up-sampling layer (Lay(4)) that places groups (260) of up-sampled pixels to the retained position (262) to the property map (270) with map-pixels.

According to embodiment 4, which includes the subject matter of embodiment 3, the computer (350) pools the feature maps to pool-maps by applying maximum pooling.

According to embodiment 5, which includes the subject matter of embodiment 1, the computer (350) receives the surface image at the first layer of the neural network (370) as channel data.

According to embodiment 6, which includes the subject matter of embodiment 5, the computer (350) receives the surface image (210) as an image having RGB channels.

According to embodiment 7, which includes the subject matter of embodiment 5, the computer (350) receives the surface image (210) also for infrared color, wherein multiple channels are allocated to multiple spectral lines of radiation emitted from the physical object (100).

According to embodiment 8, which includes the subject matter of embodiment 6, the computer (350) receives the image data in multiple channels from a camera (310) that comprises a hyperspectral camera sensor.

According to embodiment 9, which includes the subject matter of any one of the preceding embodiments, the computer (350) receives the surface image (210) from a camera on board of an unmanned aerial vehicle (340) flying over the physical object (100).

According to embodiment 10, which includes the subject matter of embodiment 1, the steps are performed by a computer running a neural network (370) of the U-Net type.

According to embodiment 11, which includes the subject matter of any one of the preceding embodiments, the property values (V(X,Y)) are real numbers, or wherein the property values (V(X,Y)) are classifiers.

According to embodiment 12, which includes the subject matter of any one of the preceding embodiments, the surface property values are relative values in respect to a standard, or wherein the surface property values are absolute values.

According to embodiment 13, which includes the subject matter of any one of the preceding embodiments, further comprising to derive an accumulated property value (V) for the physical object (100), the accumulated value being calculated as average property value over the pixels of the property map (270).

According to embodiment 14, which includes the subject matter of any one of the preceding embodiments, further comprising to provide the surface property values (V(X,Y)) as a two-dimensional map (“heatmap”, “mask”) in a pixel resolution that substantially corresponds to the pixel resolution of the surface image (210).

According to embodiment 15, which includes the subject matter of any one of the preceding embodiments, the physical object (100) and the property values are agricultural field and growth values.

According to embodiment 16, there is provided a computer-implemented method (600) to train a neural network (370) with a training set comprising surface images (215) with annotated surface properties values for physical objects (100) that are shown on the surface images (215), wherein training surface images (210) had been communicatively coupled to the input of at least one convolutional layer and the property values (V_train) had been communicatively coupled to a global average module (G_AVG) that calculates the global average of map-pixels of the property map (270) at the output of the at least one convolutional layer.

According to embodiment 17, which includes the subject matter of embodiment 16, characterized by training a neural network (370) to operate in a method according to any of embodiments 1-15.

According to embodiment 18, there is provided a computer adapted to perform any of the method (400/600) according to any one of embodiments 1-17.

According to embodiment 19, there is provided a computer program product that—when loaded into a memory of a computer and being executed by at least one processor of the computer—performs the steps of the computer-implemented method according to any one of embodiments 1-18.

According to embodiment 20, there is provided using the quantified properties of the physical object obtained by performing a method according to any of embodiments 1 to 17, by an object modifier (610) that receives a point-specific property value (V(x,y) from the property map (270) and triggers the operation of a point-specific actuator (620) that acts on a point-specific location of the surface (110).

### BRIEF DESCRIPTION OF THE DRAWINGS

FIG. 1 illustrates a system for quantifying properties of physical objects;

FIG. 2 illustrates position correspondence from an object surface to a surface image and to a property map;

FIG. 3 illustrates the property map with property pixels by way of example;

FIG. 4 illustrates data channels in the surface image;

FIG. 5 illustrates a legend with a network layer and its input and output maps, in isolation;

FIG. 6 illustrates a pooling layer that retains position information and an up-sample layer that retrieves the position information;

FIG. 7 illustrates network layers in cooperation with each other in a simplified overview to the network;

FIG. 8 illustrates the training process for the network;

FIG. 9 illustrates an object modifier that acts on the physical object according to property values obtained from the system of FIG. 1;

FIG. 10 illustrates a flow-chart of a computer-implemented method for quantifying properties of a physical object in the granularity of individual surface points of the object, and

FIG. 11 illustrates a generic computer system.

FIG. 12 illustrates an exemplary system for quantifying properties of an agricultural field.

FIG. 13 illustrates an exemplary UI of a software application.

FIG. 14 illustrates an exemplary system for field management.

FIG. 15 illustrates a flow chart describing a method for field management.

FIG. 16 shows an exemplary system for quantifying properties of an industrial product.

### DETAILED DESCRIPTION

### Conventions

The description frequently refers to the first scenario: the physical objects are agricultural fields. The reader can apply the disclosure to other scenarios, such as to the above-mentioned second scenario in industrial manufacturing.

The description uses some conventions: references 1** point to the physical object in the real world (physical world); references 2** point to data; references 3** point to hardware and to computer-implemented modules; and references 4** point to method steps. Since machine learning (ML) is involved, training the neural network is required (training phase). The following description assumes the operation of the neural network in the testing phase (that is when training has already been performed). However, the description will shortly explain aspects of the training at the end.

For convenience, phrases such as “the network calculates” or the “the network provides” are short statements describing the operation of the computer that implements the network. The description explains surface positions with (X,Y) coordinates that are simplified for illustration, and explains position data in images and maps by pixel coordinates (x,y), again simplified. The skilled person can apply coordinates in other formats.

### System Overview

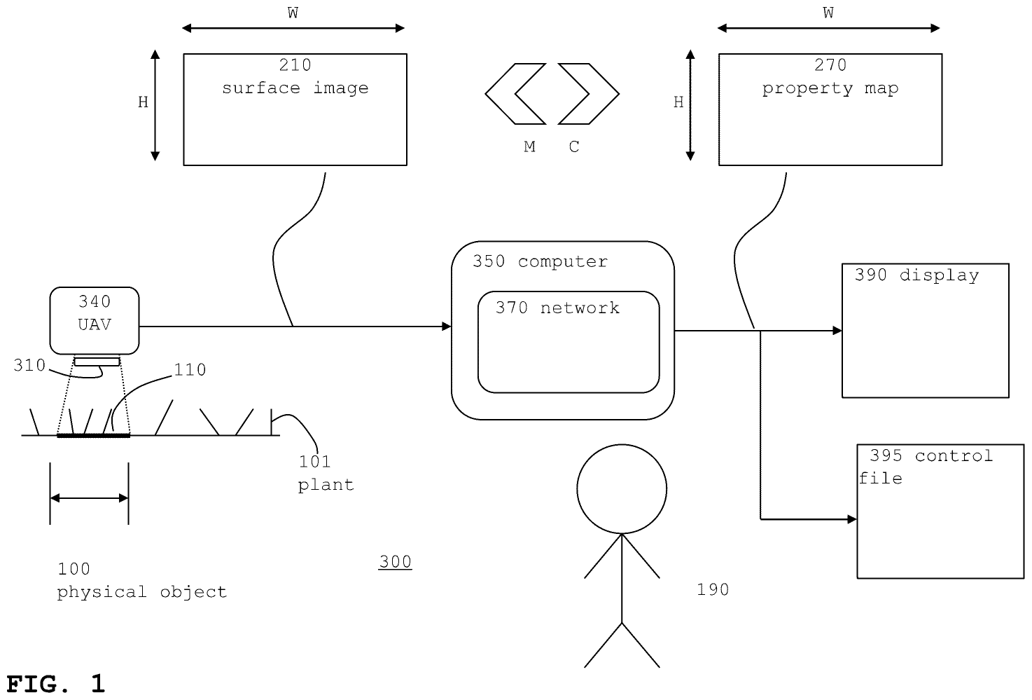

The description provides an overview by referring to FIGS. 1-3.

FIG. 1 illustrates system 300 for quantifying properties of physical objects 100 (and their individual surface points). From left to right, FIG. 1 illustrates physical object 100 with surface 110, surface image 210 (taken from surface 110 by camera 310), computer 350 (with neural network 370 to process surface image 210 to property map 270), and as well as (optional) display 390 that can present quantified properties (of object 100) to user 190.

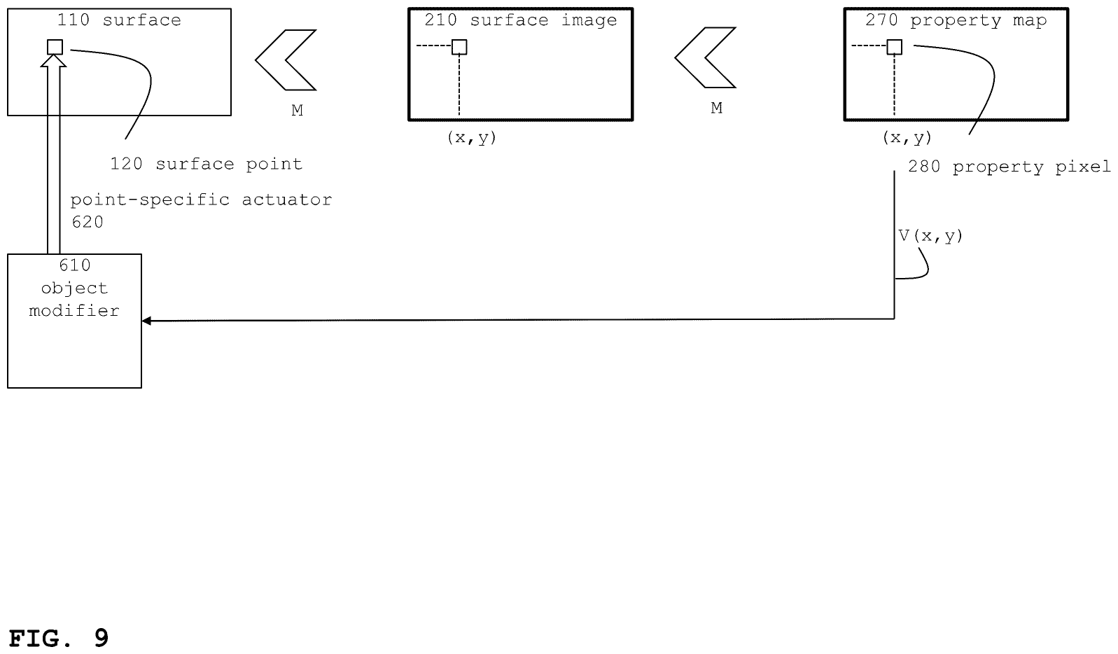

In some examples, a damage location may be identified based on the property map, and a control file 395 may be generated which is preferably usable for controlling a treatment device, such as a point-specific actuator to reduce the damage in the damaged location. This will be explained in detail hereinafter and in particular with respect to the example shown in FIGS. 9, 14 and 15.

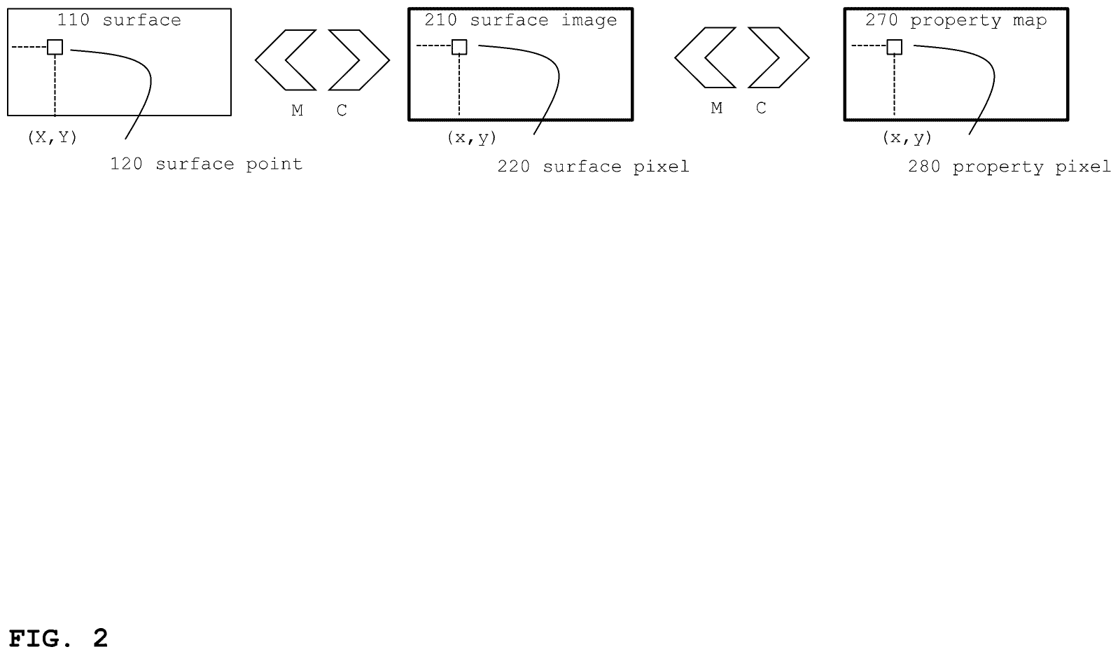

FIG. 2 illustrates position correspondence from surface 110 to surface image 210 and to property map 270, with surface point 120, surface pixel 220 and property pixel 280, respectively. The figure illustrates surface point 120 as an example of multiple surface points by that the surface can be virtually divided, and the figure applies the same principle to the property pixels.

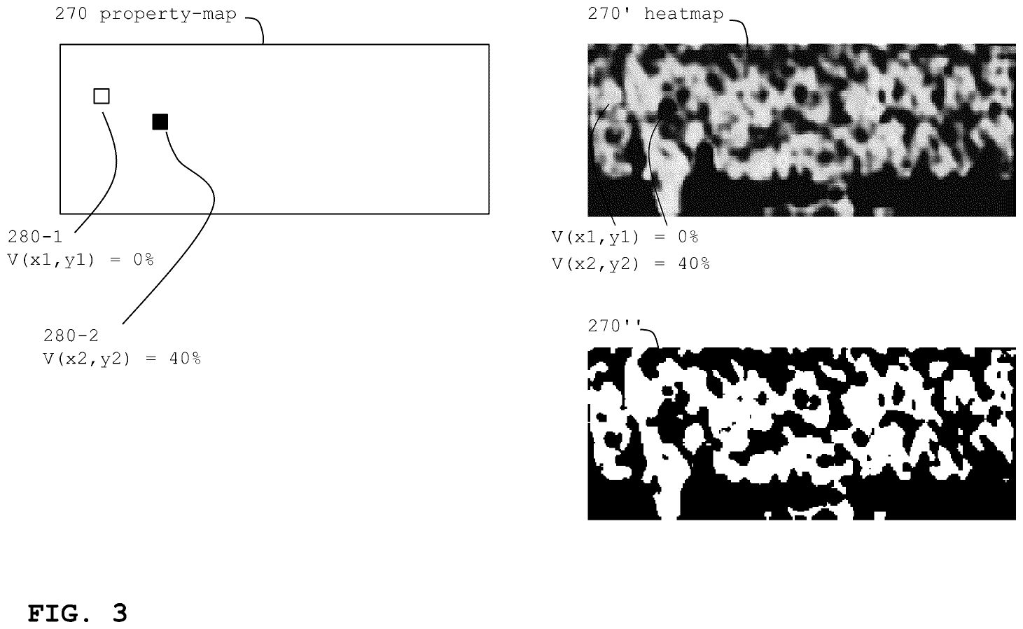

FIG. 3 illustrates property map 270 with property pixel 280 by way of example.

On the left, FIG. 1 illustrates physical object 100 with surface 110 and illustrates surface image 210. Although FIG. 1 is a simplified block diagram, it also gives an example for the first scenario in that physical object 100 is an agricultural field. FIG. 1 illustrates the field in a side-view in that surface 110 is symbolized as a horizontal line. FIG. 1 also shows an environment (e.g., the particular field and its neighboring fields, thinner lines). Surface 110 and surface image 210 are also illustrated in FIG. 2.

Both FIG. 1 and FIG. 2 illustrate position correspondence with an “>” arrow (label C) and illustrate position matching with an “<” arrow (label M).

As in FIG. 2, position correspondence (here indicated left to right) allows that position data (x,y) of individual property pixel 280 matches (right to left) the real-world position (X,Y) of surface point 120. Surface point 120 has a (real-world) property, and property pixel 280 gives an estimation for that property as a property value.

### Example

By way of example, the properties of the field (i.e., object 100) of interest should be damage to plants 101 that grow on the field. In FIG. 1, surface 110 has three plants 101, and surface image 210 would show three plants only. In real-world scenarios, the number of plants is much higher (potentially hundreds of plants on the field).

The term “plant damage” as used in the context of the present application is any deviation from the normal physiological functioning of a plant which is harmful to a plant, including but not limited to plant diseases (i.e. deviations from the normal physiological functioning of a plant) caused by a) fungi (“fungal plant disease”), b) bacteria (“bacterial plant disease”), c) viruses (“viral plant disease”), d) insect feeding damage, e) plant nutrition deficiencies, f) heat stress, for example temperature conditions higher than 30° C., g) cold stress, for example temperature conditions lower than 10° C., h) drought stress, i) exposure to excessive sun light, for example exposure to sun light causing signs of scorch, sun burn or similar signs of irradiation, j) acidic or alkaline pH conditions in the soil with pH values lower than 5 and/or pH values higher than 9, k) salt stress, for example soil salinity, or l) destructive weather conditions, for example hail, frost, damaging wind.

In general, the properties of physical object 100 influence its surface 110. Therefore, processing images from surface 110 can indicate properties that may be hidden within physical object 100. Topic j) is an example for that. The soil is not part of the surface, but the computer can quantity damage by processing the surface image.

In the example, camera 310 is illustrated by being mounted on an UAV 340 (or “drone”). UAV 340 would fly over the field so that camera 310 would take camera-images. The dashed lines symbolize the field-of-view (FOV) of camera 310 (corresponding to a single camera-image). UAV 340 is a convenient placeholder for other arrangements to hold camera 310. In an auxiliary process, a computer (associated with the camera, not illustrated) can process the camera-images to surface images 210. As used herein, camera 310 takes a single surface image for a single surface of a single object. This process is much simplified. As the skilled person understands, camera 310 can take multiple images and combine them to a single surface image 210 (using well-known techniques such as for getting so-called panorama pictures). Or, camera 310 can take a camera-image showing multiple surfaces and split the camera-image to surface images (showing a single surface of a single object each). The skilled person can combine the approaches and proceed otherwise.

Camera 310 (and or UAV 340) can also collect metadata (such as geographical positions of the object, time stamps etc.).

Using UAVs to fly cameras over agricultural fields is known in the art, but just to give the reader some further background, the following approach may be convenient: For example, UAV 340 would fly at an altitude between 10 and 100 meters over the field, and its camera 310 would capture camera-images with a 1280×960 pixel sensor. UAV 340 would fly in zig-zag pattern (as if the farmer would draw the plow), and it would take a camera-image every 2 or 3 meters. The exact distance does not matter, because UAV 340 also records geographic location data (altitude, latitude, data from the Global Positioning System or from other satellite positioning systems).

The applicant conducted experiments with a large agricultural environment that has been divided into so-called plots. A plot is a field (i.e., object 100) with a rectangular surfaces of approximately 5×2 meters). There was an inter-plot margin of approximately 0.5 meter between adjacent plots. Such an approach is convenient, but the fields do not require visible margins or the like. Surface image 210 (for such a plot) has an exemplary pixel dimensions of (W, H)=(330, 80) pixels.

FIG. 3 illustrates property map 270 with two individual property pixels 280-1 and 280-2 corresponding to different positions on the field. The pixels have property values: value V(x1,y1) indicates 0% damage, and value V(x2,y2) indicates 40% damage. Property map 270 can have values in the same number as it has pixels (e.g., W*H).

FIG. 3 also illustrates optional heatmaps 270′ and 270″ (on display 390), in that the property values are assigned to pre-defined display colors (or gray-scales). The selection of the color does not matter, but it is convenient to provide heatmaps like a whether forecast map. In the example of heatmap 270′ there is “blue” for relative low values 0-20%, “green” for medium value 21-60%, “red” for relatively high values 61-100%). The term “heatmap” is a metaphor, but does not display temperature.

### Processing Surface Images by the Computer

Returning to FIG. 1, the center part of the figure illustrates computer 350 that performs a (computer-implemented) method for quantifying properties of physical object 100. In the first scenario, this would be a method for quantifying plant damage in agricultural fields. The skilled person can implement computer 350 by a general-purpose computer having a central processing unit (CPU) and optionally having one or more graphics processing units (GPU).

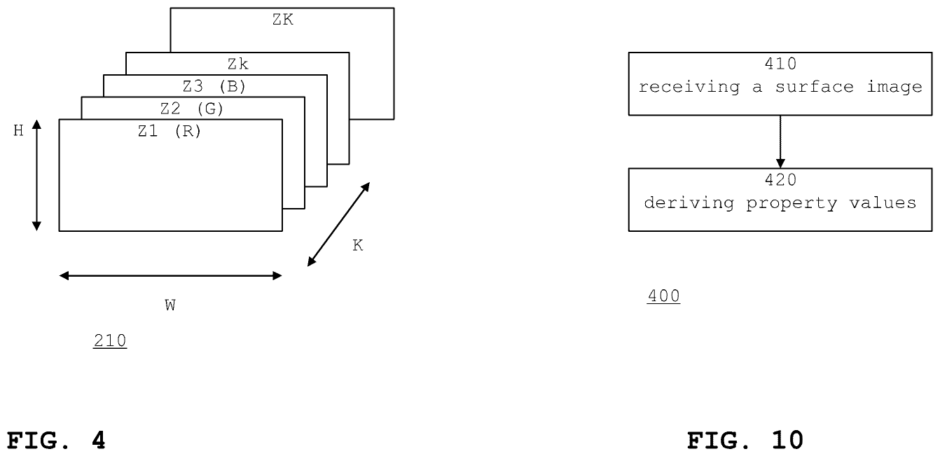

One of the first steps is receiving surface image 210 at the input of neural network 370 (at computer 350). While maintaining the above-mentioned position correspondence, computer 350 then provides property map 270. FIG. 1 symbolizes the correspondence by illustrating surface image 210 and property map 270 by rectangles of equal size (for example, equal pixel dimensions (W, H). Details for the operation of computer are explained connection with FIGS. 4-8.

The figure illustrates computer 350 in functional terms, but the implementation can vary. The skilled person can distribute functions to physical components that are different. Convenient examples comprise computers installed at UAV 340, computers installed installed remotely (e.g., software as a service, SaaS), computer being integral part of a mobile device, or otherwise.

### Property Map Provided by the Computer

The right part of the figure illustrates that neural network 370 provides property map 270, and that computer 350 can—optionally—forward property map 270 to display 390. Display 390 can be the display of a mobile device in the hands of user 190 who can be the farmer working on the field. User 190 can inspect the object properties to identify appropriate (counter) measures. The visualization of property map 270 by display 390 (in form of a heatmap) is not required, but convenient for the user.

In the first scenario, first example, user 190 would apply measures by distributing fungicides in appropriate amounts.

As the computer quantifies properties of physical object 100 in the granularity of individual surface points of physical object 100, FIG. 2 illustrates surface 110 with individual surface point 120, and illustrates property map 270 with property pixels 280.

As already mentioned, there is position correspondence. The position (X, Y) of individual surface point 120 (of surface 110) corresponds to individual pixel position data (x, y) of individual surface pixel 220 (within surface image 210). Computer 350 maintains that position correspondence: individual pixel position data (x, y) of surface image 210 corresponds to individual pixel position data (x, y) of individual property pixel 280 of property map 270.

Position correspondence can be implemented by keeping the pixel dimensions. In the example, both surface image 210 and property map have (W, H)=(300, 200) pixels.

### Modality of Property Values

The computer provides the property values V(x,y) in property map 270 as numeric values, with substantially each value pixel being related to a pixel (pixel-related). The numeric values V(x,y) are available in the single-channel of property pixels.

Regarding the modality of the property values, they can be real numbers (such as percentages, cf. FIG. 3) or they can be binary classifiers (indicating the presence or absence of a particular property).

In view of the first scenario, first example, the farmer can apply chemical products in appropriate amounts (e.g., amount of a fungicide) depending on a damage percentage, in theory different for each point. In a simplified approach, the computer provides a classification (such as growth/no-growth, damage/no-damage) and the farmer can differentiate between application and non-application of fungicide).

### Optional Surface-Related Values

Optionally, a computer can aggregate the pixel-related property values V(x, y) to surface-related values V, for example, by calculating the average of V(x, y) over all pixels. Such an aggregation requires relatively few computation efforts and can be performed for example by the computer that controls display 390.

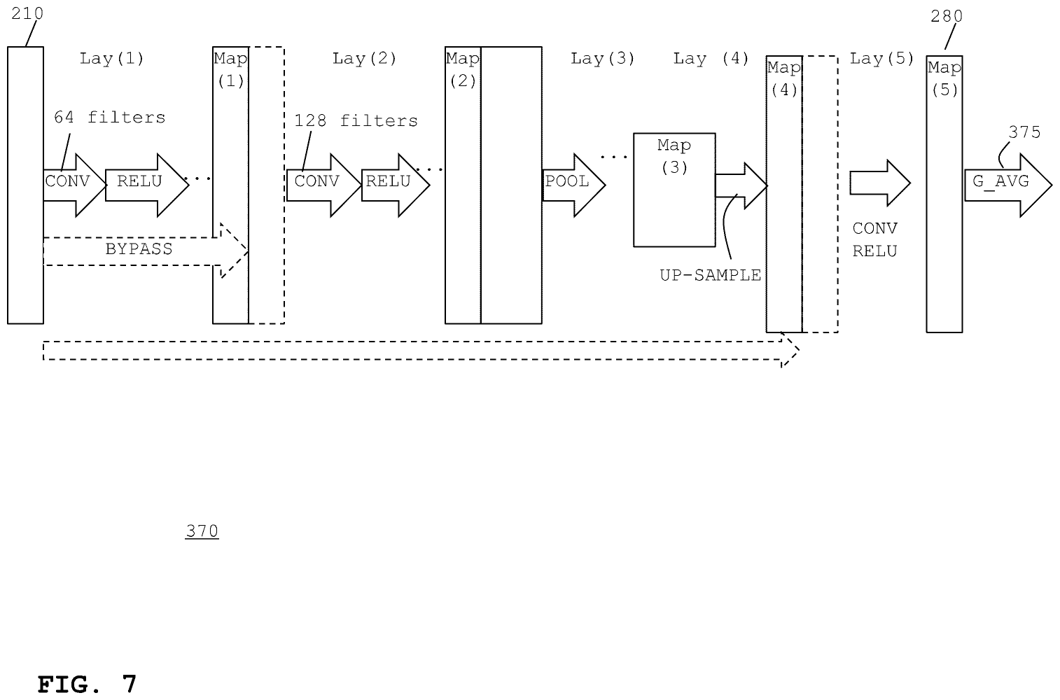

The average calculation can be also be performed by the aggregator (global average layer, cf. FIG. 7) in network 370. There is a synergetic effect because computer 250 uses the aggregator also during training.

The person of skill in the art can apply other aggregating approaches. For example, if the number of output pixels in the “damage” classification exceeds a pre-defined threshold (e.g., 50% of the pixels) the computer could classify physical object 100 as “damaged”.

In terms of machine learning, the damage estimations are predictions.

### Data Channels in the Surface Image

FIG. 4 illustrates surface image 210 with data channels. Surface image 210 has its pixel arranged with width W and height H. There are W*H pixels. Each pixel has channel data Z(x, y) being a vector with K channels (Z1, Z2, Z3, Zk, . . . , ZK). The number of channels can also be called “depth K”. The figure illustrates the channels Zk (x, y) in separate planes.

In other words, computer 350 receives surface image 210 with real-world data for physical object 100 with channel data Zk (k=1 to K) and with position data (x, y).

Camera 310 (and/or the computer associated with the camera) codes the Zk values by an appropriate number of bits. In case of an (R, G, B) color image, Z1 can stand for Red, Z2 for Green and Z3 for Blue.

It is contemplated to use a camera that captures light at non-visible wavelength (so-called hyperspectral camera) and that stores image data for such light in further channels. In such as case, there can be Z=5 channels with Z4 standing for a wavelength for infrared, and Z5 standing for “red edge”.

Other cameras may provide K=10 channels, or even K=271 channels.

It is noted that cameras for taking pictures can have frame sensors (or “area sensors”) or line sensors.

Frame sensor cameras provide a camera image at one time. Line sensor cameras provide the image when being moved over the surface (cf. the above implementation by UAV). Line sensor cameras operate similar as flatbed scanners.

Shortly returning to FIGS. 1-3, surface image 210 is a color image (R, G, B), and heatmap 270′ can be displayed as color image as well.

Due to convolutions (by neural network 370), multiple pixels of surface image 210 result to multiple pixels in property map 270. For example, of some pixels in surface image would show a black-green-black-green pattern (similar to a “chess-board”), network 370 may classify the corresponding surface points as “damaged”. The heatmap would than show a damaged area on surface 110 as “black”.

The number K of channels corresponds to the so-called depth of the input layers of network 370 (cf. FIG. 1).

### Implementation of the Network

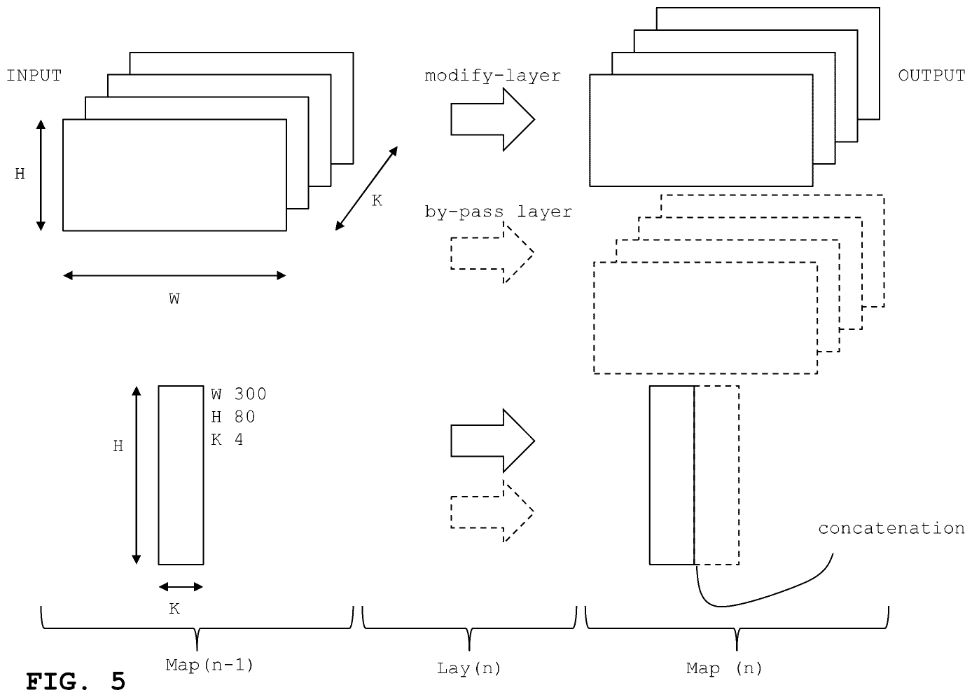

FIG. 5 illustrates a legend with a network layer and its input and output maps, in isolation. The network processes data by processing modules that are called layers. It is convenient to implement the network on a machine learning platform (such as TensorFlow) and using code libraries or frameworks that are specialized for neural networks. An example for such a library is KERAS, written in the computer language PYTHON.

For example, to specify the operation of a so-called transposed convolution layer, the skilled person can write a statement in KERAS (e.g., “Conv2DTranspose( . . . )”). In the statement, the text between the parenthesis indicates input data, output data, and other parameters.

Exemplary parameters are “kernel_size”, “strides”, “padding”, “activation”, “use_bias” and others. However, there is no need to explain all parameters, and KERAS is just an implementation option.

Some modify layers (i.e., the convolution layer) operate as filters with weights obtained by training, wherein KERAS or other frameworks provide the infrastructure for that.

FIG. 5 illustrates data (being INPUT and/or OUTPUT of a particular layer Lay(n)) by rectangles (width W×height H). The upper row of FIG. 5 illustrates the data also by multiple rectangles for multiple channels K (cf. FIG. 4), the lower row of FIG. 5 illustrates the same data in a simplified W×H notation. FIG. 5 also introduces the convention to illustrate the modify-layers by plain arrows, and to illustrates the optional bypass-layers by dashed arrows.

The modify-layer in FIG. 5 could be a RELU operation that keeps the pixel dimension of the (intermediate) map unchanged, or could be a POOL operation that modifies the pixel dimension. Modify layers can also be convolutional layers CONV that may change the pixel dimensions or keep it, depending on the selected padding.

Concatenation is an aspect of the optional by-pass layers that are illustrated by dashed lines. The by-pass layer copies channels (e.g., the K channels of an input) and place them next to the output of a modify-layer. The copied channels are not modified. The next layer (i.e., Lay (n+1), not illustrated) would then process an intermediate map with the channels from feature map (Map(n), from Lay(n)) as well and from the input (Map(n-1)). In the simplified example, there are K=4 channels at Map(n-1) being processed by modify layer Lay (n) to K=4 channel of Map(n) being concatenated with Map(n-1). The by-pass layer can support the position correspondence.

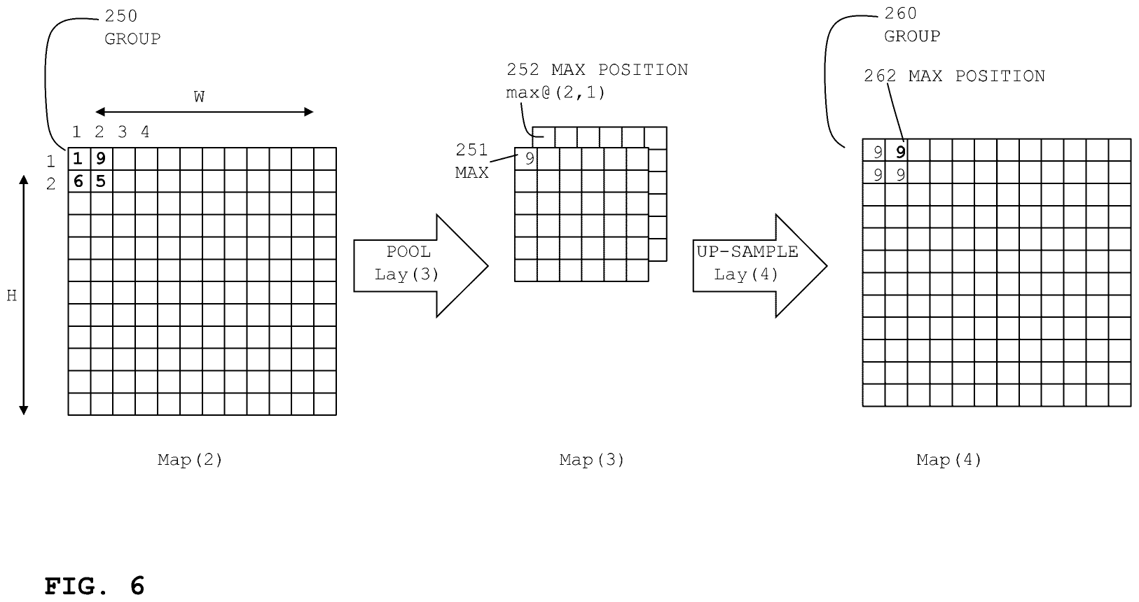

FIG. 6 illustrates pooling layer Lay(3) that retains position data (x, y) and illustrates up-sample layer (Lay(4)) that retrieves the position data. Retaining data supports position correspondence/position match (cf. the C/M arrows in FIGS. 1-2).

For convenience, FIG. 6 uses references Lay(3) and La(4) as in FIG. 7, but FIG. 6 is not limited to such use.

Optionally, the pooling layer “POOL” provides pooling. In case of maximum pooling (“max pooling”), the layer identifies the maximum value (e.g., 1 pixel out of 4 pixels) and takes this over to the OUTPUT. Pooling decreases the pixel dimension. For example, 1-of-4-pooling reduces the width to W/2 and reduces the height to H/2.

In the example, the INPUT has channel values “1”, “9”, “6” and “5” at (x, y) locations (1, 1), (2, 1), (1, 2) and (2, 2) respectively. The computer takes “9” as the maximum value over to OUTPUT at position (1, 1), keeps the information that the maximum value “9” was located at (2, 1) in the coordinates of the INPUT.

There are different approaches, for example to obtain the average value (of 4 pixels, (1+9+6+5)/4). The pooling parameter 2×2 is taken as a simplified example, the person of skill in the art can apply any other parameters. Further examples include 3×3, 4×4, . . . , 8×8 etc. Likewise, by in the other direction, UP-SAMPLE layers provide up-sampling by that the pixel dimensions are increased (usually by a factor of 2). Likewise, the position information is retained, here in the example at position (W, H)=(2, 1).

FIG. 7 illustrates network layers in cooperation with each other in a simplified overview to network 370.

A CONV layers applies convolution by so-called filters. Operating a CONV layer keeps (W, H) substantially unchanged. There are weights to be trained. A RELU layer (rectified linear activation function) provides OUTPUT=INPUT for positive INPUT otherwise OUTPUT=0. There are no weights to be trained.

Aggregator 375 with global average pooling (G_AVG) calculates the average value (e.g., the average of V (x, y) over all (x, y)).

By way of a simplified example, FIG. 7 illustrates network 370 with some layers and with some intermediate images only. The figure uses ellipsis “ . . . ” to indicate the possible implementation with further layers.

FIG. 7 illustrates date flow from left to right, with ascending index (n). Also, FIG. 7 illustrates parameters (such as number of pixels, channels, filters) for the first scenario (properties of the field). The description starts with the modify-layers.

The input receives surface image 210 (cf. FIG. 2), here in the example (W, H, K)=(330, 80, 271). Layer Lay (1) is a CONV and RELU layer. In the example, the CONV layer applies 64 filters that create 64 channels.

Map(1) keeps the pixel dimension (W, H)=(330, 80) but has K=64 channels.

Layer Lay (2) again is a CONV and RELU layer. In the example, the CONV layer applies filters that create 128 further channels.

Map(2) keeps the pixel dimension (W, H)=(330, 80) but has K=271+64+128 channels. Layer Lay (3) is a POOL layer that reduces the pixel dimension (e.g., max pooling). In view of the above-explained adaptation, the layer keeps the position data (cf. FIG. 6).

Map(3) has the reduced pixel dimension. It comprises the pixels with the maximum channel values (as explained in FIG. 6) and keeps the position data.

Layer Lay (4) provides up-sampling, and retrieves position information.

Map (4) is one of the last intermediate maps.

Layer Lay (5) is a further CONWRELU layer leading to property map 270 (or Map(5)) being property map 270 (cf. FIG. 2).

Aggregator 375 (here G_AVG) provides the surface-related value.

### Implementation for Higher Retrieval Accuracy

FIG. 7 illustrates a first bypass-layer in parallel to Lay (1). Map (2) would comprise 64 channels (from the CONV filters) as well at 271 channels (from the surface image). A second bypass-layer in parallel to Lay(1) to Lay(4) can forward original data as well.

### Training

Using neural networks (or machine learning tools in general) requires training (and validation). Much simplified, a network-under-training receives a set of training data (at the input) and updates internal weights (such as explained for FIGS. 5-6) in repetitions until it calculates a set of data (at the output) that corresponds to a known value.

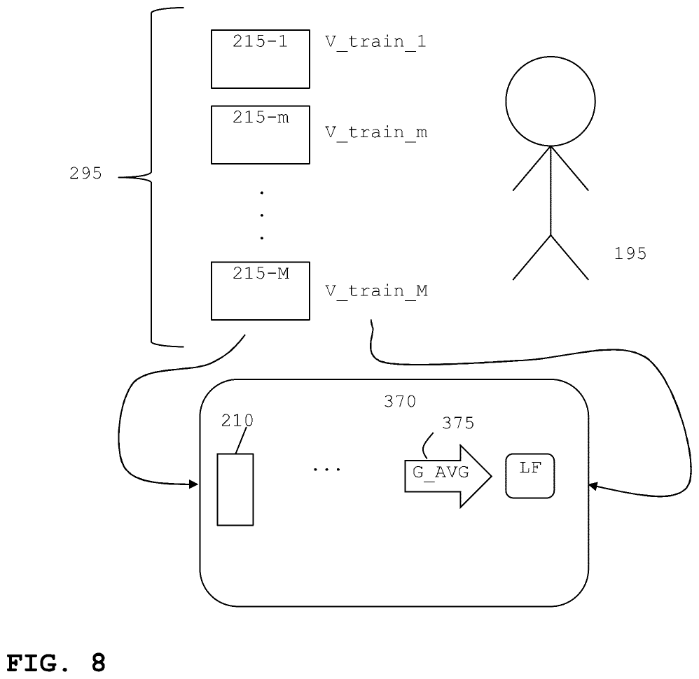

The deviations between calculated output and known (or expected) output should become minimal. The skilled person processes the deviations by so-called loss-functions and stops the repetitions when the loss-function shows a particular behavior (e.g., approaching zero). FIG. 8 illustrates the training process for network 370. The process has two phases: (first) providing the training set, and (second) applying the training set to the network.

In the first phase, human expert 195 annotates training-values V_train_1 to V_train_M to surface images 215-1 to 215-M, respectively (index m from 1 to M). For convenience of explanation, it is assumed that surface images 215 have substantially the same pixel dimensions as surface images 210 (cf. FIGS. 1-2). This however not required.

The number of surface images 215-1 to 215-M and the corresponding number of annotations is M. For example, M=1.000. Training set 295 therefore comprises surface images with previously annotated training-values.

The modality of the training-values fits to the modality of the property values (to be predicted later). Training with real numbers (such as percentages, cf. FIG. 3) leads to property values that are real numbers, training with binary classifiers (indicating the presence or absence of a particular property) leads to property values that are binary values. The granularity of the training-values is that of surface-related values. Usually, known training values corresponds to the ground truth (i.e., empirical evidence). Since point-related values are not available at ground truth quality for training (expert user 195 does not have them at that granularity), the training is therefore performed with value that applicable for the surface as a whole.

In can happen that expert user 195 can't inspect a particular surface (e.g., the point of the field) in real-world. However, user 195 can look at images 215-1 to 215-M.

Form a different perspective, the output of neural network 370 (i.e., property map 270) is “dense” because it differentiates property values for each pixel, but the annotations are not “dense” at all. As explained, the annotations V_train_1 to V-train_M are applicable for images as a whole.

In view of the first scenario, expert user 195 annotates training-values that are damage percentages (i.e., real numbers representing damages of the field). In the example, expert user 195 assigns the percentages in a granularity 0% (expert user 195 does not see any damage) to 100% (expert user 195 understands a surface image to origin from a field that is damaged completely). A step spacing of 5% is convenient. There is no need for expert user 195 to identify the area within the object surface where the damage occurs.

Expert user 195 has the expertise of a field biologist. Expert user 195 is understood as a role that can be performed by different persons. The field biologist is not necessarily the farmer user (user 190 of FIG. 1). Human experts may have conducted experiments by that fields with known damage data have been photographed.

In a first variation, the annotations can be classes (e.g., DAMAGE/NO-DAMAGE) the output would be classes as well.

In a second variation, the annotations are numeric values that correspond to damage ranges, such as SMALL/MEDIUM/HEAVY.

In the second phase (illustrated below) does not longer require the expert user.

The surface images 215-1 to 215-M are supplied (in sequences) to the input of network 370 (symbolized by image 210) and the training-values (V_train_1 to V_train_M) are supplied to a loss-function block LF at the output of aggregator 375. For simplicity, the figure omits well-known components, such as the feedback connection from LF to the layers.

During training with all M surface images 215, network 370 adapts the weights to calculate V1 to VM for surface images 215-1 to 215-M and and applies a loss-function to calculate an error (in comparison to the annotation).

The function is related to the definition of the property values. For regression (property values are real numbers), the loss-function is one of the following: MAE (mean absolute error), MSE (mean square error), LogCosh (log hyperbolic cosine). For binary classification, the loss-function is one of the following: binary cross-entropy, hinge loss, squared hinge loss. For multi-class classification, the loss function is one of: multi-class cross-entropy loss, sparse multiclass cross-entropy loss, or Kullback-Leibler divergence loss.

In repetitions (with other weights), network 370 selects weights for that the loss becomes minimal. (The prediction is a regression because network 370 predicts V(x, y) being real numbers, or a classification with V(x, y) given in binary or multi-class categories).

In other words, network 370 receives the surface image and derives property values (as explained above) by being a neural network that has been trained previously with a plurality of annotated training images 215, being training surface images 215 with expert-annotated property values V_train, wherein the training surface images 215 had been communicatively coupled to the input of the at least one convolutional layer (such as Lay(1) in FIG. 7) and the expert-annotated property values V_train had been communicatively coupled to a global average module (such as G_AVG in FIGS. 7-8) that calculated the global average of map-pixels of the property map 270.

### Ronneberger

The person of skill in the art is able—based on the description herein—to implement neural network 370 by modifying a known network, such as the U-Net described by Ronneberger et al. The modification mainly relates to implementing the position retention in the pooling and up-sampling layers.

While Ronneberger et al use an input layer that receives an image 572×572×1, network 370 uses a modified input layer that receives the surface images in a different dimension (W×H×K), for example 330×80×271. As explained above, the number of channels K can be relatively high (such as K=271), and neural network 370 just scales the input to further convolutions. Not all channels may contain relevant data, so that—especially for the channels in the non-visible spectra—the filter weights may become substantially zero.

### Other Scenarios

Regarding other scenarios (such as the second scenario), the skilled person can easily replace the UAV by different devices, if needed. In industrial environments, cameras could be mounted to trolleys on bridge cranes or the like. Such cameras can take images from physical objects that are arranged horizontally. Industrial settings allow the installation of cameras that are exactly focused to the objects. Potentially, pre-processing images (such as cutting images, removing overlap etc.) may not be required in such scenarios.

### Using the Properties

FIG. 9 illustrates object modifier 610 that acts on the physical object 110 according to property values V(x,y) obtained from system 300 (cf. FIG. 1).

FIG. 9 cites surface 110, surface image 210 and property map 270 from FIG. 2.

As illustrated on the left side, object modifier 610 uses the quantified properties of the physical object as input information. In the example, modifier 610 receives property value V(x,y) from system 300 (cf. FIG. 1). The property value is point-specific due to the above-explained matching (M). Modifier 610 triggers the operation of point-specific actuator 620 that acts on a point-specific location of the surface 110.

To give an example for the first scenario, the plants are damaged by fungi at a point with location (X,Y). Actuator 620 can be a machine that applies fungicide to that location. In other setting, actuator 620 removes weed from particular locations, spray chemical compounds etc.

To give an example for the second scenario, a mat can be dirty at a particular point so that the actuator 620 (being a cleaning device) just cleans the dirty part.

The operation of actuator 620 is not limited to a single specific point, its operator can apply measures to substantially all points of the object, with point-specific intensity derived from the property map.

### Method

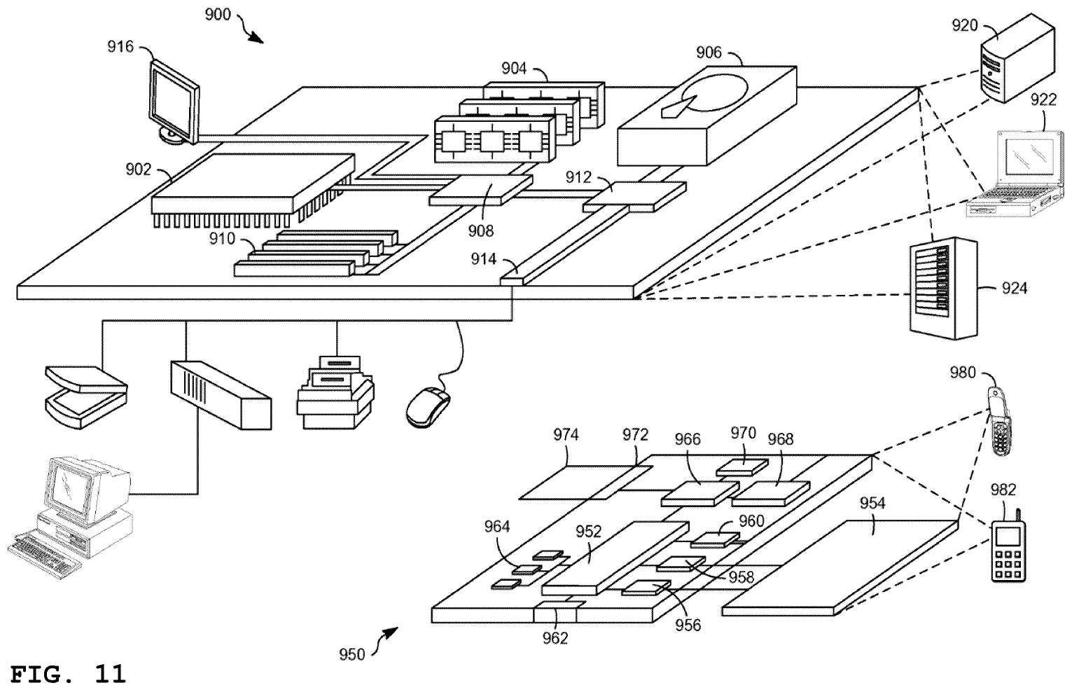

FIG. 10 illustrates a flow-chart of a computer-implemented method 400 for quantifying properties of physical object 100 in the granularity of individual surface points 120 of the physical object 100.

In a receiving step 410, the computer receives surface image 210 with real-world data for physical object 100 with channel data Zk and with position data (x,y), wherein the position data (x,y) of the pixels in the surface image 210 match the positions (X,Y) of surface points 120 within physical object 100.

In a deriving step 420, the computer derives property values V(X,Y) being point-related values, by operating neural network 370, wherein neural network 370 provides at least one feature map Map(1) at the output of at least one convolutional layer Lay(1), the at least one feature map being property map 270 having a pixel dimension (W, H) that corresponds to the pixel dimension (W, H) of the surface image.

Neural network 370 has been trained previously with a plurality of annotated training images 215, being training surface images 215 with expert-annotated property values V_train, wherein training surface images 210 had been communicatively coupled to the input of the at least one convolutional layer Lay(1) and the expert-annotated property values V_train had been communicatively coupled to a global average module G_AVG that calculated the global average of map-pixels of property map 270.

### Computer System

FIG. 11 illustrates an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Generic computer device may 900 correspond to computers 201/202 of FIGS. 1-2. Computing device 950 is intended to represent various forms of mobile devices, such as personal digital assistants, cellular telephones, smart phones, and other similar computing devices. For example, computing device 950 may include the data storage components and/or processing components of devices as shown in FIG. 1. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk. The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 984 may also be provided and connected to device 950 through expansion interface 982, which may include, for example, a SIMM (Single In Line Memory Module) card interface. Such expansion memory 984 may provide extra storage space for device 950, or may also store applications or other information for device 950. Specifically, expansion memory 984 may include instructions to carry out or supplement the processes described above, and may include secure information also. Thus, for example, expansion memory 984 may act as a security module for device 950, and may be programmed with instructions that permit secure use of device 950. In addition, secure applications may be provided via the SIMM cards, along with additional information, such as placing the identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 984, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 980 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing device that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing device can include clients and servers. A client and server are generally remote from each other and typically interact through a communication network. The relationship of client and server arises by virtue of computer programs running on the respective computers and having a client-server relationship to each other.

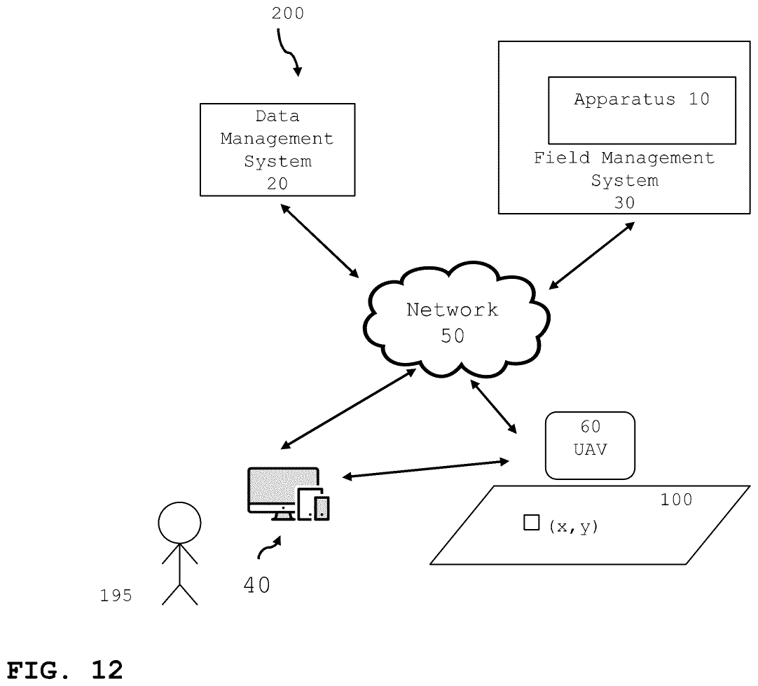

FIG. 12 illustrates an exemplary system 200 for quantifying properties of an agricultural field. The system 200 comprises a data management system 20, a field management system 30, an electronic communication device 40, a network 50, and a treatment device 60. In this example, the apparatus 10 is embodied as, or in, the field management system 30, e.g., residing in the field management system 30 as a software. Further, the apparatus 10 is configured to generate a trained neural network usable for determining a damage status of a physical object.

The data management system 20 of the illustrated example may store databases, applications, local files, or any combination thereof. The data management system 20 may comprise data obtained from one or more data sources. In some examples, the data management system 20 may include data obtained from a user device, which may be a computer, a smartphone, a tablet, a smartwatch, a monitor, a data storage device, or any other device, by which a user, including humans and robots, can input or transfer data to the data management system 20. In some examples, the data management system 20 may comprise data obtained from one or more sensors. The term “sensor” is understood to be any kind of physical or virtual device, module or machine capable of detecting or receiving real-world information and sending this real-world information to another system, which may include temperature sensor, humidity sensor, moisture sensor, pH sensor, pressure sensor, soil sensor, crop sensor, water sensor, cameras, or any combination thereof. In some examples, the data management system 20 may store one or more databases, which may be any organized collection of data, which can be stored and accessed electronically from a computer system, and from which data can be inputted or transferred to the data management system 20. In some examples, the data management system 20 may comprise information about one or more agricultural fields 100. For example, the data management system 20 may comprise field data of different agricultural fields. The field data may include georeferenced data of different agricultural areas and the associated treatment map(s). The field data may comprise information about one or more of the following information: crop present on the field (e.g. indicated with crop ID), the crop rotation, the location of the field, previous treatments on the field, sowing time, etc.

The field management system 30 of the illustrated example may be a server that provides a web service e.g., to the electronic communication device 40. The field management system may comprise a data extraction module (not shown) configured to identify data in the data management system 20 that is to be extracted, retrieve the data from the data management system 20, and provide the retrieved data to the apparatus 10, which processes the extracted data according to the method as described herein. The processed data and the final outputs of the apparatus 10 may be provided to a user output device (e.g., the electronic communication device 40), in an output database (e.g., in the data management system 20), and/or as a control file (e.g., for controlling the treatment device 60). The term “user output device” is understood to be a computer, a smartphone, a tablet, a smartwatch, a monitor, a data storage device, or any other device, by which a user, including humans and robots, can receive data from the field management system, such as the electronic communication device 40. The term “output database” is understood to be any organized collection of data, which can be stored and accessed electronically from a computer system, and which can receive data, which is outputted or transferred from the field management system 30. For example, the output database may be provided to the data management system 20. The term “control file”, also referred to as configuration filed, is understood to be any binary file, data, signal, identifier, code, image, or any other machine-readable or machine-detectable element useful for controlling a machine or device, for example the treatment device 60. In some examples, the apparatus 10 may provide an application scheme, which may be provided to the electronic communication device 40 to allow the farmer to configure the treatment device 60 according to the application scheme. In some examples, the apparatus 10 may provide a configuration profile, which may be loaded to the treatment device 60 to configure the treatment device 60 to spread crop protection products according to the determined application timing.

The electronic communication device 40 of the illustrated example may be a desktop, a notebook, a laptop, a mobile phone, a smart phone and/or a PDA. The electronic communication device 40 may comprises an application configured to interface with the web service provided by the field management system 30. The application may be a software application that enables a user to manipulate data extracted from the data management system 20 by the field management system 30 and to select and specify actions to be performed on the individual data. For example, the application may be a desktop application, a mobile application, or a web-based application. The application may comprise a user interface, such as an interactive interface including, but not limited to, a GUI, a character user interface, and a touch screen interface. Via the software application, the user may access the field management system 30 using e.g., Username and Password Authentication to obtain an application scheme and/or configuration file usable for configuring the treatment device 60. The application scheme and/or the configuration file may comprise a dose rate map e.g., with one or more crop protection product IDs.

The treatment device 60 of the illustrated example may comprise any device being configured to perform a measure to reduce the damage. In the case of agricultural field, the treatment device may apply a crop protection product onto an agricultural field. The application device may be configured to traverse the agricultural field. The application device may be a ground or an air vehicle, e.g. a tractor-mounted vehicle, a self-propelled sprayer, a rail vehicle, a robot, an aircraft, an unmanned aerial vehicle (UAV), a drone, or the like. In the example of FIG. 12, the treatment device 60 may be a UAV. The treatment device 60 may include a connectivity system (not shown), The connectivity system may be configured to communicatively couple the UAV to the computing environment. For example, the UAV may receive the configuration file from the field management system 30 or from the electronic communication device 40, and apply a crop protection product according to the dose rate map specified in the configuration file.

The network 50 of the illustrated example communicatively couples the data management system 20, the field management system 30, the electronic communication device 130, and the treatment device 60. In some examples, the network 50 may be the internet. Alternatively, the network 50 may be any other type and number of networks. For example, the network 50 may be implemented by several local area networks connected to a wide area network. For example, the data management system 20 may be associated with a first local area network, the field management system 30 may be associated with a second local area network, and the electronic communication device 40 may be associated with a third local area network. The first, second, and third local area networks may be connected to a wide area network. Of course, any other configuration and topology may be utilized to implement the network 50, including any combination of wired network, wireless networks, wide area networks, local area networks, etc.

The training process for network shown in FIG. 8 will be described hereinafter with respect to the system shown in FIG. 12. The process has two phases: (first) providing the training set, and (second) applying the training set to the network.

In the first phase, human expert 195 may annotate training-values V_train_1 to V_train_M to surface images 215-1 to 215-M, respectively (index m from 1 to M), using the electronic communication device 40. The surface images 215-1 to 215-M may be obtained from the data management system 20 or from the UAV 60. The expert user 195 annotates training-values that are damage percentages (i.e., real numbers representing damages of the field).

In the example, expert user 195 assigns the percentages in a granularity 0% (expert user 195 does not see any damage) to 100% (expert user 195 understands a surface image to origin from a field that is damaged completely). A step spacing of 5% is convenient. There is no need for expert user 195 to identify the area within the object surface where the damage occurs.

Via the UI of the software application, the human expert 195 can provide the annotated training data to the field management system 30 for training the neural network in the apparatus 10. In some examples, the annotated data may be provided to a training database in the data management system. The apparatus 10 may then retrieve training data from the training dataset stored in the data management system 20.

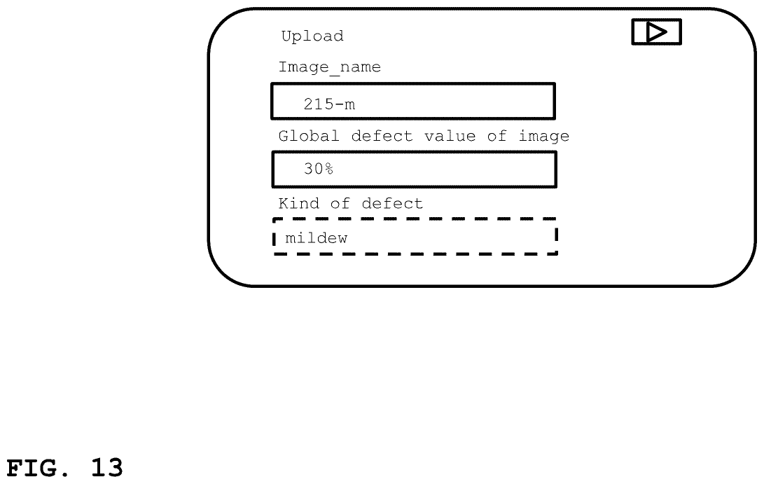

An exemplary UI of the software application is shown in FIG. 13. The human expert 195 may enter the image name in the field “image_name” and annotated training values in the field “Global defect value of image”. As described above, the global defect value of image may be damage percentages (i.e., real numbers representing damages of the field). In the example, expert user 195 assigns the percentages in a granularity 0% (expert user 195 does not see any damage) to 100% (expert user 195 understands a surface image to origin from a field that is damaged completely). A step spacing of 5% is convenient.

The second phase does not longer require the expert user 195. Once the training data is ready, the apparatus 10 is configured to train the neural network according to the method disclosed herein. An exemplary training method is described in FIG. 8.

After training, the trained neural network can be deployed for field management.

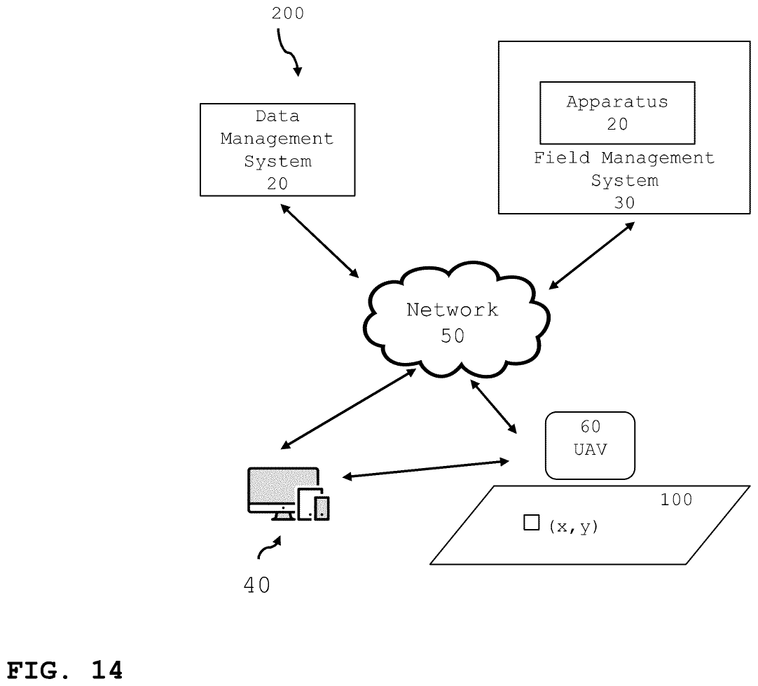

FIG. 14 illustrates an exemplary system 200 for field management. The system 200 shown in FIG. 14 may have similar structure as the system 200 shown in FIG. 12. The difference is that the apparatus 20 comprises a trained neural network. In FIGS. 12 and 14, the apparatus 10 and apparatus 20 are shown as separate apparatuses. In some examples (not shown), the apparatus 10 and apparatus 20 may be embodied as, or in, a single device.

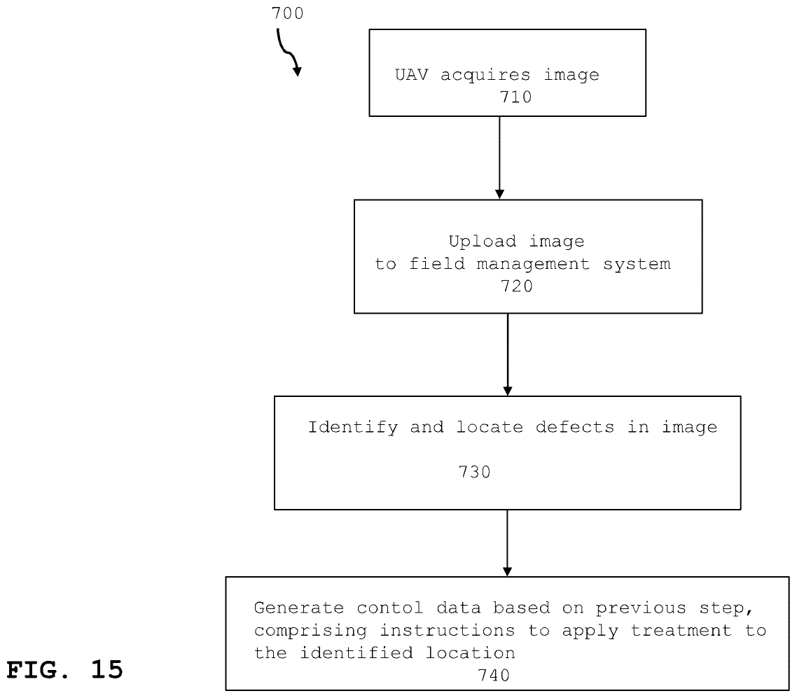

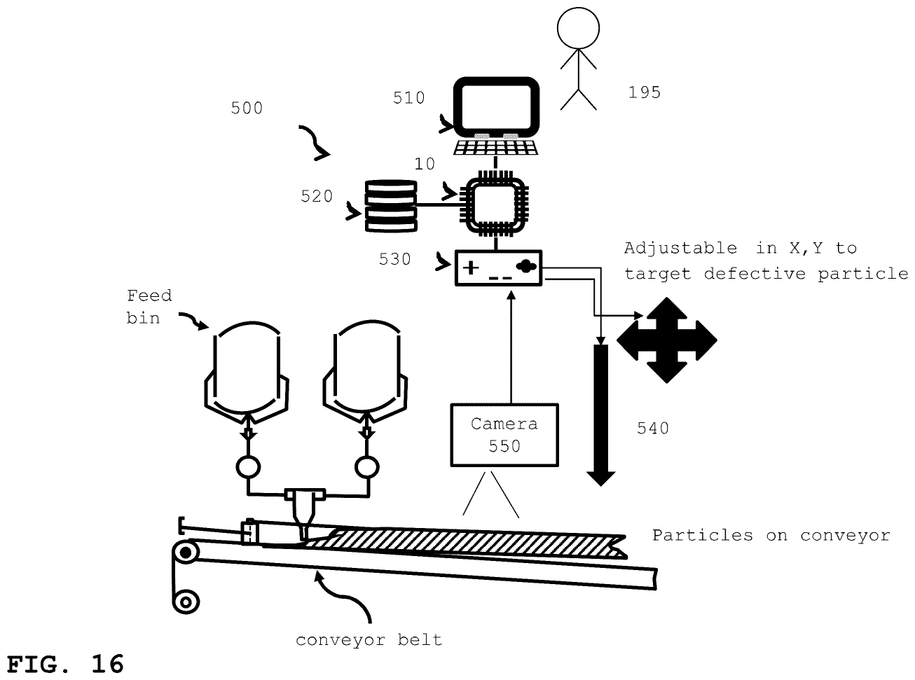

FIG. 15 illustrates a flow chart describing a method 700 for field management, which will be described in connection with the system 200 shown in FIG. 14.

Beginning at block 710, an image of the agricultural field 100 can be acquired by a camera, which may be mounted on a UAV 60 shown in FIG. 14, aircraft or the like. It possible for the UAV to automatically take the individual images without a user having to control the UAV.

At block 720, the acquired image is uploaded to the field management system 30. If multiple images are acquired, these images may be provided to the field management system 30 for stitching the taken images together. Notably, the individual images can be transmitted immediately after they have been taken or after all images have been taken as a group. In this respect, it is preferred that the UAV 60 comprises a respective communication interface configured to directly or indirectly send the collected images to the field management system 30, which could be, e.g. cloud computing solutions, a centralized or decentralized computer system, a computer center, etc. Preferably, the images are automatically transferred from the UAV 60 to the field management system 30, e.g. via an upload center or a cloud connectivity during collection using an appropriate wireless communication interface, e.g. a mobile interface, long range WLAN etc. Even if it is preferred that the collected images are transferred via a wireless communication interface, it is also possible that the UAV 60 comprises an on-site data transfer interface, e.g. a USB-interface, from which the collected images may be received via a manual transfer and which are then transferred to a respective computer device for further processing.

At block 730, using the trained neural network, the apparatus 20 is configured to identify and locate defects in the image. For example, the apparatus may detect damaged plants, e.g., plants damaged by fungi at a point with location (X,Y).

At block 740, the apparatus 20 or the field management system 30 may generate a control file based on identified damaged location. The control file may comprise instructions to move to the identified location and to apply treatment. The identified location may be provided as location data, which may be geolocation data, e.g. GPS coordinates. The control file can, for example, be provided as control commands for the treatment device, which can, for example, be read into a data memory of the treatment device before the treatment of the field, for example, by means of a wireless communication interface, by a USB-interface or the like. In this context, it is preferred that the control file allow a more or less automated treatment of the field, i.e. that, for example, a sprayer automatically dispenses the desired herbicides and/or insecticides at the respective coordinates without the user having to intervene manually. It is particularly preferred that the control file also include control commands for driving off the field. It is to be understood that the present disclosure is not limited to a specific content of the control data, but may comprise any data needed to operate a treatment device.

FIG. 16 shows an exemplary system 500 for quantifying properties of an industrial product. The system 500 may comprise an electronic communication device 540, a database 520, an apparatus 10, an object modifier 530, a treatment device 540, and a camera 550.

In general, the apparatus 10 may comprise various physical and/or logical components for communicating and manipulating information, which may be implemented as hardware components (e.g. computing devices, processors, logic devices), executable computer program instructions (e.g. firmware, software) to be executed by various hardware components, or any combination thereof, as desired for a given set of design parameters or performance constraints.

In some examples, as shown in FIG. 16, the apparatus 10 may comprise one or more microprocessors or computer processors, which execute appropriate software. The software may have been downloaded and/or stored in a corresponding memory, e.g. a volatile memory such as RAM or a non-volatile memory such as flash. The software may comprise instructions configuring the one or more processors to perform the functions described herein. It is noted that the apparatus 10 may be implemented with or without employing a processor, and also may be implemented as a combination of dedicated hardware to perform some functions and a processor (e.g. one or more programmed microprocessors and associated circuitry) to perform other functions. For example, the functional units of the apparatus 10, e.g. the input unit, the one or more processing units, and the output unit may be implemented in the device or apparatus in the form of programmable logic, e.g. as a Field-Programmable Gate Array (FPGA). In general, each functional unit of the apparatus may be implemented in the form of a circuit.

The apparatus 10 may be embodied as, or in, a workstation or server. The apparatus 10 may provide a web service e.g., to the electronic communication device 510.

The electronic communication device 510 of the illustrated example may be a desktop, a notebook, a laptop, a mobile phone, a smart phone and/or a PDA. The electronic communication device 100 may comprise an application configured to interface with the web service provided by the apparatus 10. For example, the application may be a desktop application, a mobile application, or a web-based application. The application may comprise a user interface, such as an interactive interface including, but not limited to, a GUI, a character user interface, and a touch screen interface. The application may be a software application that enables a user to submit annotated training data e.g., to the database 520.

The database 520 may store annotated training data and images captured by the camera 550.

An exemplary UI of the software application is shown in FIG. 13. The human expert 195 may enter the image name (e.g., 215-m) in the field “image_name” and annotated training values in the field “Global defect value of image”. As described above, the global defect value of image may be damage percentages (i.e., real numbers representing damages of the captured image). In the example, expert user 195 assigns the percentages in a granularity 0% (expert user 195 does not see any damage) to 100% (expert user 195 understands a surface image to origin from a field that is damaged completely). A step spacing of 5% is convenient.

The training process for network shown in FIG. 8 will be described hereinafter with respect to the system shown in FIG. 16. The process has two phases: (first) providing the training set, and (second) applying the training set to the network.

In the first phase, human expert 195 may annotate training-values V_train_1 to V_train_M to surface images 215-1 to 215-M, respectively (index m from 1 to M), using the electronic communication device 510. The surface images 215-1 to 215-M may be obtained from the database 520. The expert user 195 annotates training-values that are damage percentages (i.e., real numbers representing damages of the surface). In the example, expert user 195 assigns the percentages in a granularity 0% (expert user 195 does not see any damage) to 100% (expert user 195 understands a surface image to origin from a field that is damaged completely). A step spacing of 5% is convenient. There is no need for expert user 195 to identify the area within the object surface where the damage occurs.

Via the UI of the software application (e.g., the UI shown in FIG. 13), the human expert 195 can provide the annotated training data to the field management system 30 for training the neural network in the apparatus 10. In some examples, the annotated data may be provided to a training database in the database 520. The apparatus 10 may then retrieve training data from the training dataset stored in the database 520.

The second phase does not longer require the expert user 195. Once the training data is ready, the apparatus 10 is configured to train the neural network according to the method disclosed herein. An exemplary training method is described in FIG. 8.

The deployment of the neural network in FIG. 9 will be described hereinafter with respect to the system shown in FIG. 16. The camera 550 can take images from particles on a conveyor belt. The images are provided to the apparatus 10. Using the trained neural network, the apparatus 10 is configured to detect damaged location, where it surfaces may show a deviation from normal (or from a standard). The object modifier 530 may receive the location information of the damaged location from the object modifier 530, and trigger the treatment device 540 to act on the damaged location of the surface. The operation of treatment device 540 is not limited to a single specific point, its operator can apply measures to substantially all points of the object, with point-specific intensity derived from the property map. For example, as shown in FIG. 16, the system may be used to detect defective particles on the conveyor belt. If it is detected that one or more defective particles at one or more points, the treatment device (e.g., an air blower) which can be controlled by the object modifier 530 to remove the defective particles from the conveyor belt.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A computer-implemented method for determining a damage status of a physical object, the method comprising the following steps:
receiving a surface image of the physical object; and
providing a pre-trained machine learning model to derive property values (V(X,Y)) from the received surface map, wherein each property value is indicative of a damage index at a respective location (X, Y), wherein the property values are usable for monitoring and/or controlling a production process of the physical object.

2. A method for controlling a production process, comprising:
capturing a surface image of a physical product;
providing a pre-trained machine learning model to derive property values (V(X,Y) from the received surface map, wherein each property value is indicative of a damage index at a respective location (X, Y);
identifying and locating based on the derived property values, a damaged location; and
generating control data that comprises instructions for controlling a treatment device to apply treatment to the identified location.

3. The method according to claim 1,
wherein the pre-trained machine model has been trained on a training set that comprises surface images with annotated surface properties values for physical objects that are shown on the surface images, wherein the annotated surface properties values comprise a percentage of an imaged surface area of the physical object being damaged.

4. The method according to claim 1, further comprising:
if the damage index at a surface area is equal to or greater than a threshold, determining that the surface area is a damaged location.

5. The method according to claim 1,
wherein the damage index of one or a plurality of surface areas of the physical object is provided as a damage percentage, which is usable to determine an amount of treatment to be applied to the one or the plurality of surface areas.

6. The method according to claim 5, further comprising:
generating, based on the damage index of the one or the plurality of surface areas of the physical object, an application map indicative a two-dimensional spatial distribution of an amount of the treatment which should be applied on different surface areas of the physical object.

7. The method according to claim 1,
wherein the physical object comprises an agricultural field, and the treatment comprises an application of a product for treating a plant damage; or
wherein the physical object comprises an industrial product, and the treatment comprises a measure to reduce the deviation of the one or the plurality of surface areas.

8. A computer-implemented method for generating a trained neural network usable for determining a damage status of a physical object, the method comprising:
providing a training set comprising surface images with annotated surface properties values for physical objects that are shown on the surface images, wherein the annotated surface properties values comprise a damage index indicative of a percentage of an imaged surface area of the physical object being damaged; and
training the neural network with the provided training set, wherein in the training process, training surface images are communicatively coupled to the input of at least one convolutional layer of the neural network and the property values (V_train) are communicatively coupled to a global average module (G_AVG) that calculates the global average of map-pixels of the property map at the output of the at least one convolutional layer.

9. The computer-implemented method according to claim 8,
wherein the physical object comprises an agricultural field, and the damage index is indicative of a plant damage.

10. The computer-implemented method according to claim 8,
wherein the physical object comprises an industrial product, and the damage index is indicative of a deviation of the one or more surface areas from a standard.

11. The computer-implemented method according to claim 8,
wherein the property values (V(X,Y)) are real numbers, or wherein the property values (V(X,Y)) are classifiers.

12. The computer-implemented method according to claim 8,
wherein the property values are relative values in respect to a standard, or wherein the surface property values are absolute values.

13. The computer-implemented method according to claim 8,
wherein the property values (V(X,Y)) are provided as a two-dimensional map in a pixel resolution that substantially corresponds to the pixel resolution of the surface image.

14. The computer-implemented method according to claim 8, further comprising a step of providing by a user and/or receiving by the user the neural network.

15. The computer-implemented method according to claim 8, further comprising a step of providing a user interface allowing a user to provide the surface images and the annotated surface properties values.

16. An apparatus for generating a trained neural network usable for determining a damage status of a physical object, the apparatus comprising:
an input unit configured to receive a training set comprising surface images with annotated surface properties values for physical objects—that are shown on the surface images wherein the annotated surface properties values are indicative of a damage index of one or a plurality of surface points and/or areas of the physical object;
a processing unit configured to train the neural network with the provided training set, wherein in the training process, training surface images are communicatively coupled to the input of at least one convolutional layer of the neural network and the property values (V_train) are communicatively coupled to a global average module configured to calculate the global average of map-pixels of the property map at the output of the at least one convolutional layer; and
an output unit configured to provide the trained neural network, which is usable for determining a damage status of a physical object.

17. An apparatus for determining a damage status of a physical object, the apparatus comprising:
an input unit configured to receive a surface image 210 of the physical object and
a processing unit configured to apply a pre-trained machine learning model to derive property values (V(X,Y) from the received surface map, wherein each property value is indicative of a damage index at a respective location (X, Y); and
an output unit configured to provide the property values, which are usable for monitoring and/or controlling a production process of the physical object.

18. A system for controlling a production process, comprising:
a camera configured to capture a surface image of an physical object;
an apparatus according to claim 17 configured to provide property values derived from the received surface map, wherein each property value is indicative of a damage index at a respective location (X, Y); and
an object modifier configured to perform, based on the property values, an operation to act on the one or more damaged locations of the physical object.

19. A computer program product comprising instructions which, when the program is executed by a processing unit, cause the processing unit to carry out the steps of the method of claim 1.

20. A computer program product comprising instructions which, when the program is executed by a processing unit, cause the processing unit to carry out the steps of the method of claim 8.
